(19) United States
(12) Patent Application Publication
(10) Pub. No.: US 2018/0148596 A1
(43) Pub. Date: May 31, 2018

(54) HIGH TEMPERATURE STABLE, ONE-PART, CURABLE THERMOSET COMPOSITIONS

(71) Applicant: 3M INNOVATIVE PROPERTIES COMPANY, St. Paul, MN (US)

(72) Inventors: Mario A. Perez, Burnsville, MN (US); Jeremy M. Higgins, Roseville, MN (US)

(21) Appl. No.: 15/573,710

(22) PCT Filed: May 16, 2016
(86) PCT No.: PCT/US2016/032638

§ 371 Date: Nov. 13, 2017

Related U.S. Application Data
(60) Provisional application No. 62/164,181, filed on May 20, 2015.

(51) Int. Cl. C09D 163/00; C09D 7/61; F16L 9/133

(52) U.S. Cl. CPC C09D 163/00; F16L 9/133; C09D 7/61

(57) ABSTRACT

One-part curable compositions include a thermally curable powder composition with at least one solid epoxy resin, and at least one solid epoxy curative resin. The epoxy resin and the epoxy curative resin are melted, mixed, quenched and powderized. The solid epoxy resin may include a benzofuran diepoxide, a modified benzofuran diepoxide, or a combination thereof.

### FIELD OF THE DISCLOSURE

The present disclosure relates to one-part high temperature stable, curable thermoset compositions, especially epoxy-based compositions, and coatings prepared from these compositions.

### BACKGROUND

A wide variety of thermoset compositions have proven useful in a wide variety of applications. Thermoset compositions are those materials that irreversibly cure to form a hard or rigid material. This is in contrast to a thermoplastic material which becomes pliable or moldable above a specific temperature and solidifies upon cooling, and is able to repeat these processes, that is to say the material upon cooling is able to be reheated to become pliable or moldable and then solidify upon cooling. Thermoset compositions are used in a number of different applications including surface protection, bonding, and the like.

There are typically two types of thermoset compositions, frequently referred to as “one-part” or “two-part” formulations.

In two-part formulations, as the name implies, there are two different reaction mixtures that are mixed together and cured to form the thermoset matrix. Typically each of the two parts contains a reactive material that when mixed with the other part reacts to form the thermoset matrix. One or both of the two parts may also contain additional additives such as fillers, property modifiers, and the like. The two parts are kept separate to prevent premature reaction and thus an advantage of two-part compositions is that as long as the two parts are kept separate the composition is stable. There are a number of drawbacks of two-part compositions including the need to store, ship, and handle the two separate components separately, and the need to control the mixing process. Mixing must be controlled so as to provide the proper ratio of reactive components and also to ensure that a generally homogeneous mixture is formed, because once curing takes place an irreversible matrix is formed. Depending upon the nature of the materials involved, control of mixing can be a complex undertaking.

One-part compositions on the other hand have all of the components already mixed together into a single composition. Thus the one-part composition need only be dispensed and cured without the need for carefully controlled mixing. However, since the components in the one-part composition are by nature reactive with each other, there are drawbacks to this type of composition as well. Depending upon the reactivity of the reactive components, the one-part formulation may either have a relatively short shelf life or the composition might need to be stored at a reduced temperature (in a refrigerator or freezer for example). Some one-part compositions are relatively stable at ambient temperatures, but may require high temperatures to fully cure, temperatures that may be too high for use in certain applications.

Epoxy resins are a commonly used class of thermoset materials. The epoxy resins are often cured with a curing agent such as an alcohol or amine which ring opens the epoxy ring forming a rigid matrix. Epoxy resins are supplied both in one-part and two-part compositions. Typically two-part compositions cure at a relatively low temperature, even room temperature and typically have the epoxy resin in one-part and an amine or other curing agent in the other part. One-part epoxy resin compositions are available in a wide variety of forms such as films, pastes, and powders. Examples of one-part epoxy compositions include epoxy adhesive films used for example in aerospace applications, epoxy paste adhesives, and epoxy powders used as protective coatings for rebar, pipes and the like.

One characteristic of epoxy compositions, and thermoset compositions in general, is that because the cured matrices are rigid, they tend to be brittle. Brittle materials are ones that have hardness and rigidity but little tensile strength, breaking or shattering easily. A great deal of research has been invested into addressing this issue, including the development of new epoxy resins, new curing agents, and property modifying agents used to modify the brittleness.

In U.S. Pat. No. 8,679,632 (Smith), a fusion bonded epoxy coating composition is described which includes at least one epoxy resin, at least one catechol novolak-type adhesion promoter, and magnesium oxide. U.S. Pat. No. 7,670,683 describes a damage-resistant epoxy composition that includes a cross-linkable epoxy resin, a polystyrene-polybutadiene-polymethylmethacrylate tri-block copolymer, and a filler material.

In US Patent Publication Nos. 2014/0069583 and 2014/0296447 (Kincaid et al.), epoxy resins with high thermal stability and toughness are described that contain (i) a polyepoxide resin, (ii) a benzofuran diol component, a benzofuran di-epoxide component or a mixture thereof, and (iii) a curing agent.

### SUMMARY

Disclosed herein are one-part high temperature stable, curable thermoset compositions, especially epoxy-based compositions, and coatings prepared from these compositions. In some embodiments, the one-part curable composition comprises a thermally curable powder composition comprising at least one solid epoxy resin, and at least one solid epoxy curative resin. The epoxy resin and the epoxy curative resin are melted, mixed, quenched and powderized. In some embodiments, the at least one solid epoxy resin comprises an epoxy resin that is a benzofuran diepoxide, a modified benzofuran diepoxide, or a combination thereof.

Also disclosed are methods of preparing coatings. In some embodiments, the method of preparing a coating comprises providing a curable composition, providing a substrate comprising a first major surface and a second major surface, coating the curable composition on at least one major surface of the substrate, and curing the curable composition. The curable composition comprises at least one solid epoxy resin, and at least one solid epoxy curative resin, where the epoxy resin and the epoxy curative resin are melted, mixed, quenched and powderized.

Also disclosed are articles which contain coatings. In some embodiments, the article comprises a first substrate having a first major surface and a second major surface, and a coating of a curable composition on at least a portion of at least one major surface of the substrate. The curable composition comprises at least one solid epoxy resin, and at least one solid epoxy curative resin, where the epoxy resin and the epoxy curative resin are melted, mixed, quenched and powderized. In some embodiments, the curable composition is cured.

### DETAILED DESCRIPTION

Thermoset compositions, particularly thermoset coatings, have proven useful in a wide variety of applications including surface protection, bonding, and the like. Epoxy resin compositions are a particularly useful class of thermoset materials that have many desirable features including high internal strength. This high internal strength provides durable protective coatings and adhesives with high adhesion to a wide range of substrates. However, cured epoxy coatings also have drawbacks. In particular, cured epoxy coatings tend to be brittle and also, in order to form a coating with high temperature stability, often the resins require very high temperatures and/or long curing times. The need for high temperature and/or long time curing can make them unsuitable for many substrates that cannot sustain these curing conditions.

Therefore, curable epoxy resin systems which are less brittle, and can be cured at relatively lower temperatures and for shorter times and yet have high temperature stability are desirable and are still being sought. Systems that are less brittle are often described as having improved “toughness”. The desired tougher epoxy coatings would have improved flexibility and ductility without sacrificing the high Tg (glass transition temperature) values associated with these coatings and which tend to give them high temperature stability.

In US Patent Publication Nos. 2014/0069583 and 2014/0296447 (Kincaid et al.), epoxy resins with high thermal stability and toughness are described that contain (i) a polyepoxide resin, (ii) a benzofuran diol component, a benzofuran di-epoxide component or a mixture thereof, and (iii) a curing agent. In these formulations, chain extension is used to help give these cured coatings improved toughness and also to impart the desirable feature of moisture resistance.

A drawback of the compositions described by Kincaid et al. is that they are “two-part compositions”, meaning that the epoxy resin/change extension agents and curatives are kept separate and mixed immediately prior to use. The disadvantage of this type of composition is that reactive components must be kept separate until use and then mixed in specific ratios, and upon mixing have a specified pot life (i.e. time after when the mixture is no longer usable) as the curing reaction can begin to occur.

In this disclosure, one-part curable compositions are described that comprise a thermally curable powder composition comprising: at least one solid epoxy resin; and at least one solid epoxy curative resin, where the epoxy resin and the epoxy curative resin are melted, mixed, quenched and powderized. Thus the curable powders of the present disclosure can be coated onto substrates and cured to form desirable epoxy coatings without the need to mix the reactive compositions. The use of one-part compositions provides for increased productivity and convenience as the coating compositions need not be precisely measured or mixed.

The terms “a”, “an”, and “the” are used interchangeably with “at least one” to mean one or more of the elements being described.

The term “adhesive” as used herein refers to polymeric compositions useful to adhere together two adherends.

The term “thermoset” refers to those materials that irreversibly cure to form a hard or rigid material.

The terms “Tg” and “glass transition temperature” are used interchangeably and refer to the glass transition temperature of a cured composition. Typically, unless otherwise specified, the glass transition temperature is measured by DMA (Dynamic Mechanical Analysis) using well understood techniques.

The terms “benzofuran” and “coumarone” are used interchangeably and have their normal chemical meaning.

The terms “room temperature” and “ambient temperature” are used interchangeably to mean temperatures in the range of 20° C. to 25° C.

The term “powderized”, also sometimes referred to as pulverized, refers to a process in which a sold material is broken up into a powder material.

As used herein, the term “high temperature stable” or “high temperature stability” refers to cured compositions that are stable at temperatures near or even above their Tg, and retain their desirable properties at these temperatures.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

Disclosed herein are one-part curable compositions comprising a thermally curable powder composition, where the thermally curable powder composition comprises at least one solid epoxy resin, and at least one solid epoxy curative resin, where the epoxy resin and the epoxy curative resin are melted, mixed, quenched and powderized. In this way the one-part curable powder composition can be coated onto a substrate or dissolved in a solvent to prepare a solvent-borne curable composition, coated and cured to form an epoxy coating.

In this way the curable powder of this disclosure is different from a simple mixture of powders because a mixture of powders would comprise particles of solid epoxy resin and particles of solid epoxy curative resin. The presently disclosed curable powder on the other hand comprises particles that are a mixture of solid epoxy resin and solid epoxy curative resin.

Suitable solid epoxy resins include the benzofuran diepoxides, modified benzofuran diepoxides, and combinations thereof described in US Patent Publication Nos. 2014/0069583 and 2014/0296447 (Kincaid et al.). Particularly suitable is the diglycidyl ether of 3,8-dihydroxy-5a,10b-diphenyl coumarano-2′,3′,2,3-cuomarane (DGE DDCC) commercially available from Huntsman Advanced Materials, The Woodlands, Tex. as RDS 2012-027. The structure of this compound is shown as Formula 1 below. Also suitable is a modified variant of DGE DDCC commercially available from Huntsman Advanced Materials, The Woodlands, Tex. as RDS 2013-059. DGE DDCC from the reaction of 3,8-dihydroxy-5a,10b-diphenyl coumarano-2′,3′,2,3-cuomarane (DGE DDCC) with epichlorohydrin.

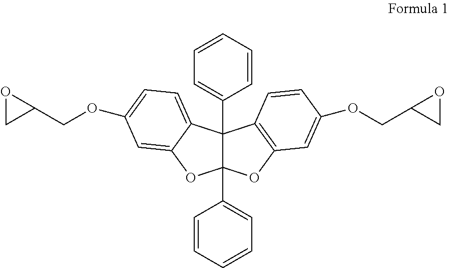 [SMILES: c1ccc(C23Oc4cc(OCC5CO5)ccc4C2(c2ccccc2)c2ccc(OCC4CO4)cc2O3)cc1]

The thermally curable powder composition also comprises at least one solid epoxy curative resin. Examples of suitable epoxy curatives include hydroxyl-functional curatives, amine-functional curatives, and anhydride-functional curatives. The solid epoxy curative may comprise a solid phenolic hydroxyl terminated curative resin, a solid anhydride curative resin, or a solid amine-based curative resin. Examples of commercially available solid phenolic hydroxyl terminated curative resins include the EPIKURE P-201 and P-202 Curing Agents from HEXION, Columbus, Ohio. Examples of suitable solid anhydride curative resins include hexahydrophthalic anhydride (HHPA), Phthalic anhydride (PA), and tetrahydrophthalic anhydride (THPA).

Amine-based curative resins are particularly suitable for use in the thermally curable powder compositions of the present disclosure. Examples of suitable solid amine-based curative resins include cyanoguanidine, diphenyl sulfone diamine curatives, imidazoles, or combinations thereof. The solid amine-based curative cyanoguanidine, also called dicyandiamide (DICY), is a particularly useful solid amine curative resin.

To prepare the thermally curable powder compositions, the solid epoxy resin and solid epoxy curative resin are melted, mixed, quenched and powderized. As will be discussed in greater detail below, the solid epoxy resin and epoxy curative resin can be mixed and heated to form a molten composition, or the solid epoxy resin can be melted and the solid epoxy resin added to the molten solid epoxy resin, where the solid epoxy curative resin melts in the molten epoxy resin to form a molten composition. The epoxy resin and epoxy curative resin are heated to a temperature of from 100-250° C. for 1-3 minutes, with mixing, and quenched by cooling to room temperature. The quenching can be carried out by removing the heat source and permitting the mixture to cool to ambient temperature, or more typically, the mixture can be placed into a cooling bath such as a water bath to facilitate cooling. The resulting quenched solid can be powderized or pulverized using standard techniques for such processes, such as with a hand grinder or a mechanized grinder.

Because the molten mixture is a thermally curable mixture, some care should be exercised to minimize the time at the elevated temperature, for example mixing the composition for 5 minutes at elevated temperature may result in the initiation of cure.

Typically, 1-3 minutes is sufficient to form the molten mixture.

The thermally curable powder composition is curable at a temperature of from 100-400° C. for from 1 minute up to 8 hours, depending upon the choice of solid epoxy resin, solid epoxy curing agent, the relative levels of the reactive components, and whether additional non-reactive components are present in the thermally curable powder. More typically, the thermally curable powder composition is curable at a temperature of from 200-300° C. for less than 1 hour, or even a temperature of from 230-280° C. for less than 30 minutes.

The thermally curable powder composition may contain additional optional additives. These optional additives can be either solids or liquids, and reactive or unreactive. Examples of reactive components that can be added include additional solid or liquid epoxy resins, liquid epoxy curative resins, and chain extension agents. Suitable solid and liquid epoxy resins include the DGEBA-type (diglycidyl ether of bisphenol A) and DGEBF-type (diglycidyl ether of bisphenol F) epoxy resins such as those commercially available from HEXION under the trade name EPON and Dow Chemical under the trade name D.E.R. Examples of liquid epoxy curative resins include liquid aromatic and aliphatic amine compounds. Examples of suitable chain extension agents include aromatic hydroxyl-functional materials such as di-hydroxyl phenolic compounds e.g. catechol and other di-hydroxyphenols, as well as compounds such a bisphenol A and bisphenol F. Examples of additional suitable chain extension agents are included in US Patent Publication Nos. 2014/0069583 and 2014/0296447 (Kincaid et al.). Care should be taken with the use of liquid reactive compounds, so that premature curing does not occur during the heating and mixing steps.

One particularly suitable class of reactive additives are benzoxazine resins. Benzoxazine resins are compounds that contain at least two benzoxazine rings. As used herein the term “benzoxazine” is inclusive of compounds and polymers having the characteristic benzoxazine ring as shown in Formula 2 below. In Formula 2, R is the residue of a mono- or polyamine, where R represents a (hetero)hydrocarbyl groups, including (hetero)alkyl and (hetero)aryl groups.

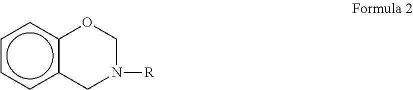

Benzoxazines and compositions containing benzoxazines are known (see for example, U.S. Pat. Nos. 5,543,516 and 6,207,786 to Ishida, et al.; S. Rimdusit and H. Ishida, “Development of New Class of Electronic Packaging Materials Based on Ternary Systems of Benzoxazine, Epoxy, and Phenolic Resins”, Polymer, 41, 7941-49 (2000); and H. Kimura, et al., “New Thermosetting Resin from Bisphenol A-based Benzoxazine and Bisoxazoline”, J. App. Polym. Sci., 72, 1551-58 (1999).

Benzoxazine resins are co-reactive with epoxy resins. It has been found that the addition of solid benzoxazine resin to the solid epoxy resin can assist in solubilizing the solid amine curing agent in the molten state. In other words, in some embodiments, blends of solid epoxy resin and solid benzoxazine resin when molten, can more readily dissolve a solid amine curing agent than can the molten solid epoxy resin by itself. This increased solubility can aid in the dispersion of the solid amine curing agent in the molten composition. When the molten composition is quenched and powder zed, the composition has improved homogeneity. Examples of a suitable benzoxazine compound are the Bisphenol A Benzoxazine resin and the Bisphenol F Benzoxazine resin commercially available under the ARALDITE trade name from Huntsman Chemical, The Woodlands, Tex. as ARALDITE MT 35600 CH (Bisphenol A Benzoxazine resin) and ARALDITE MT 35700 CH (Bisphenol F Benzoxazine resin). The benzoxazine resins can be blended with the solid epoxy resins in a range of amounts, up to equal amounts by weight, that is to say, to a ratio of 50:50 by weight. Smaller amounts of added benzoxazine resin are also useful. In some embodiments, the solid epoxy to solid benzoxazine resin ratio is 75:25 by weight, for example.

A wide range of non-reactive additives can be included in the thermally curable powder composition. Among the suitable additives are fillers, thermal conductivity enhancers, compatibilizers, particles such as nanoparticles, coupling agents, flow promotion agents, adhesion promotion agents, toughening agents, fibers, fabrics, and combinations thereof. These components are typically solids, but some of the additive components can be liquids.

Particularly suitable non-reactive additives are fillers and/or thermal conductivity enhancers such as alumina, silica, aluminosilicate compounds, magnesium oxide, beryllium oxide, diamond powder, graphitic carbon, boron nitride, silicon carbide, silver powder, copper powder, zinc oxide, and the like. A particularly suitable thermal conductivity enhancer is boron nitride.

The cured thermally curable powder compositions have a variety of desirable features, as will be described in greater detail below, including relatively high Tg, a desirable balance of mechanical features (rigidity and toughness), durability, and moisture resistance, making them suitable for use in a wide range of applications.

Also disclosed are methods of preparing coatings, the method comprising providing a curable composition, where the curable composition comprises a thermally curable powder composition as described above, providing a substrate with a first major surface and a second major surface, coating the curable composition on at least one major surface of the substrate, and curing the curable composition. As described in detail above, the thermally curable powder composition comprises at least one solid epoxy resin, and at least one solid epoxy curative resin, wherein the epoxy resin and the epoxy curative resin are melted, mixed, quenched and powderized. The thermally curable powder composition may also include other additives as described above.

The process of melting, mixing and quenching of the epoxy resin and the epoxy resin curing agent has been described above. In some embodiments, the solid epoxy resin and solid epoxy curative resin are mixed in the solid state and heated to a temperature of from 100-250° C. for 1-3 minutes and quenched by cooling to room temperature. In other embodiments, the solid epoxy resin is heated to a temperature of from 100-250° C., the solid epoxy curative resin is added with mixing, maintaining the temperature of from 100-250° C. for 1-3 minutes and quenching by cooling to room temperature. Powderizing of the quenched solid composition can be carried out by grinding or other methods of pulverizing.

In many embodiments, the thermally curable powder composition is used as a powder, but in other embodiments, the thermally curable powder may be dissolved in a solvent to provide a solvent-borne coating composition. Any suitable solvent may be used such as long as the solvent is able to sufficiently solubilize the powder and does not adversely interact with the thermally curable powder composition. Examples of suitable solvents include ketones such as acetone and methyl ethyl ketone and hydrocarbon solvents such as hexane, heptane, benzene or toluene.

The thermally curable powder composition, whether as a powder or as a solvent-borne coating composition, is coated onto at least one major surface of the substrate using conventional coating techniques. If solvent is used, the coating may be dried, or drying can be carried out as part of the curing as is described below. The thickness of the coating varies depending upon the desired use for the coating. Typically the coatings range from 25 micrometers (1 mil) to 1 millimeter in thickness.

The coating is thermally cured. If solvent was used to prepare the coating, drying and curing can be carried out simultaneously. Any suitable method of heating can be used to carry out curing such as the use of heat lamps and the like, typically ovens are used to effect the thermal curing.

Typically curing is carried out by heating the curable coating at a temperature of from 100-400° C. for from 1 minute up to 8 hours, depending upon the choice of solid epoxy resin, solid epoxy curing agent, the relative levels of the reactive components, and whether additional non-reactive components are present in the thermally curable powder. More typically, the thermally curable powder composition is cured at a temperature of from 200-300° C. for less than 1 hour, or even a temperature of from 230-280° C. for less than 30 minutes.

The coatings can be coated on a wide range of substrates. Examples of suitable substrates include metal substrates, ceramic substrates, glass substrates, or polymeric substrates. The substrates can be in a variety of shapes such as plates or tubes, and may have smooth or irregular surfaces and may be hollow or solid. In some embodiments, the substrate is a pipe and the cured composition is a pipe coating. The pipe can have a wide variety of diameters and shapes.

Also disclosed are articles, the articles comprising a first substrate having a first major surface and a second major surface; and a coating of a curable composition on at least a portion of at least one major surface of the substrate, where the coating of a curable composition is a thermally curable powder composition as described above. As described in detail above, the thermally curable powder composition comprises at least one solid epoxy resin, and at least one solid epoxy curative resin, wherein the epoxy resin and the epoxy curative resin are melted, mixed, quenched and powderized. The thermally curable powder composition may also include other additives as described above.

In some embodiments, the article further comprises a second substrate, the second substrate having a first major surface and a second major surface, where at least a portion of the first major surface of the second substrate is in contact with coating of the curable composition.

Also disclosed are articles where the coating of a curable composition has been cured as described above. The cured composition has a relatively high Tg. Typically the cured composition has a Tg as measured by Dynamic Mechanical Analysis (DMA) of at least 150-270° C.

In articles where the curable composition is used as an adhesive to adhere the first substrate to the second substrate, the cured adhesive has a high adhesive strength. The adhesive strength can be modeled by preparing and testing overlap shear samples according to the standard overlap shear test method ASTM D 1002-72 as described in the Examples section. Typically the cured composition has an overlap shear value of 1,000-4,000 pounds per square inch (6,895-27,580 kiloPascals). Additionally, the cured composition retains high adhesion even at relatively high temperatures. Because of the relatively high temperature thermal stability of the cured compositions, the cured compositions retain their overlap shear adhesion properties even at elevated temperatures.

Additionally, in some embodiments, the cured coatings have improved thermal conductivity as compared to samples of conventional cured epoxy coatings, and retain the improved thermal conductivity at elevated temperatures, even at temperatures approaching the Tg of the cured coating. The thermal conductivity can be enhanced through the use of thermal conductivity enhancers such as powdered boron nitride. In some embodiments, the cured composition has a thermal conductivity that does not decrease when measured at a temperature of from room temperature to 250° C. By this it is meant that the thermal conductivity measured at 250° C. is the same or even higher than the thermal conductivity measured at room temperature. This is atypical behavior for cured epoxy resin compositions and is reflective of the high thermal stability of the one part curable thermoset compositions of the present disclosure. The methods for measuring thermal conductivity are explained below in the Examples section.

This disclosure includes the following embodiments:

Among the embodiments are one-part curable compositions. A first embodiment includes a one-part curable composition comprising: a thermally curable powder composition comprising: at least one solid epoxy resin; and at least one solid epoxy curative resin, wherein the epoxy resin and the epoxy curative resin are melted, mixed, quenched and powderized.

Embodiment 2 is the curable composition of embodiment 1, wherein the at least one solid epoxy resin comprises an epoxy resin that is a benzofuran diepoxide, a modified benzofuran diepoxide, or a combination thereof.

Embodiment 3 is the curable composition of embodiment 1 or 2, wherein the at least one solid epoxy resin comprises an epoxy resin that is the diglycidyl ether of 3,8-dihydroxy-5a,10b-diphenyl coumarano-2′,3′,2,3-cuomarane.

Embodiment 4 is the curable composition of any of embodiments 1-3, wherein the at least one solid epoxy curative resin comprises a solid phenolic hydroxyl terminated curative resin, a solid amine-based curative resin, or a solid anhydride curative resin.

Embodiment 5 is the curable composition of embodiment 4, wherein the solid epoxy curative resin comprises an amine-based curative resin comprises cyanoguanidine, diphenyl sulfone diamine curatives, imidazoles, or combinations thereof.

Embodiment 6 is the curable composition of any of embodiments 1-5, wherein the epoxy resin and epoxy curative resin are heated to a temperature of from 100-250° C. for 1-3 minutes and quenched by cooling to room temperature.

Embodiment 7 is the curable composition of any of embodiments 1-6, wherein the curable composition is curable at a temperature of from 100-400° C. for from 1 minute up to 8 hours.

Embodiment 8 is the curable composition of any of embodiments 1-6, wherein the curable composition is curable at a temperature of from 200-300° C. for from less than 1 hour.

Embodiment 9 is the curable composition of any of embodiments 1-6, wherein the curable composition is curable at a temperature of from 230-280° C. for from less than 30 minutes.

Embodiment 10 is the curable composition of any of embodiments 1-9, further comprising at least one additive.

Embodiment 11 is the curable composition of embodiment 10, wherein the at least one additive comprises a filler, a thermal conductivity enhancer, a chain extension agent, a compatibilizer, a benzoxazine compound, a nanoparticle, a coupling agent, a flow promotion agent, an adhesion promotion agent, a toughening agent, fibers, fabrics, and combinations thereof.

Embodiment 12 is the curable composition of embodiment 11, wherein the at least one additive comprises a chain extension agent comprising an aromatic hydroxyl-functional chain extension agent.

Embodiment 13 is the curable composition of any of embodiments 1-12, further comprising at least one liquid component.

Embodiment 14 is the curable composition of embodiment 13, wherein the at least one liquid component comprises at least one liquid epoxy resin, at least liquid epoxy curative resin, or at least one liquid additive.

Also disclosed are methods of preparing coatings. Embodiment 15 includes a method of preparing a coating comprising: providing a curable composition, the curable composition comprising: at least one solid epoxy resin; and at least one solid epoxy curative resin, wherein the epoxy resin and the epoxy curative resin are melted, mixed, quenched and powderized; providing a substrate comprising a first major surface and a second major surface; coating the curable composition on at least one major surface of the substrate; and curing the curable composition.

Embodiment 16 is the method of embodiment 15, wherein providing a curable composition comprises providing a curable composition powder or a curable composition powder dissolved in one or more solvents.

Embodiment 17 is the method of embodiment 15 or 16, wherein melting, mixing and quenching the epoxy resin and epoxy curative resin comprises heating a mixture of solid epoxy resin and solid epoxy curative resin to a temperature of from 100-250° C. for 1-3 minutes and quenching by cooling to room temperature.

Embodiment 18 is the method of embodiment 15 or 16, wherein melting, mixing and quenching the epoxy resin and epoxy curative resin comprises heating a mixture of solid epoxy resin to a temperature of from 100-250° C. adding and solid epoxy curative resin and maintaining the temperature of from 100-250° C. for 1-3 minutes and quenching by cooling to room temperature.

Embodiment 19, is the method of any of embodiments 15-18, wherein curing the curable composition comprises heating to a temperature of from of from 100-400° C. for from 1 minute up to 8 hours.

Embodiment 20 is the method of any of embodiments 15-18, wherein the curable composition is curable at a temperature of from 200-300° C. for from less than 1 hour.

Embodiment 21 is the method of any of embodiments 15-18, wherein the curable composition is curable at a temperature of from 230-280° C. for from less than 30 minutes.

Embodiment 22 is the method of any of embodiments 15-21, further comprising at least one additive.

Embodiment 23 is the method of embodiment 22, wherein the at least one additive comprises a filler, a thermal conductivity enhancer, a chain extension agent, a compatibilizer, a benzoxazine compound, a nanoparticle, a coupling agent, a flow promotion agent, an adhesion promotion agent, a toughening agent, fibers, fabrics, and combinations thereof.

Embodiment 24 is the method of embodiment 23, wherein the at least one additive comprises a chain extension agent comprising an aromatic hydroxyl-functional chain extension agent.

Embodiment 25 is the method of any of embodiments 15-24, further comprising at least one liquid component.

Embodiment 26 is the method of embodiment 25, wherein the at least one liquid component comprises at least one liquid epoxy resin, at least liquid epoxy curative resin, or at least one liquid additive.

Embodiment 27 is the method of any of embodiments 15-26, wherein the substrate comprises a metal substrate, a ceramic substrate, a glass substrate, or a polymeric substrate.

Also disclosed are articles. Embodiment 28 includes an article comprising: a first substrate having a first major surface and a second major surface; and coating of a curable composition on at least a portion of at least one major surface of the substrate, wherein the curable composition comprises: at least one solid epoxy resin; and at least one solid epoxy curative resin, wherein the epoxy resin and the epoxy curative resin are melted, mixed, quenched and powderized.

Embodiment 29 is the article of embodiment 28, further comprising a second substrate, the second substrate having a first major surface and a second major surface, wherein at least a portion of the first major surface of the second substrate is in contact with coating of the curable composition.

Embodiment 30 is the article of embodiment 28 or 29, wherein the curable composition is cured.

Embodiment 31 is the article of embodiment 30, wherein the cured composition has a Tg as measured by Dynamic Mechanical Analysis (DMA) of at least 150-270° C.

Embodiment 32 is the article of embodiment 30 or 31, wherein the cured composition has an overlap shear value of 1,000-4,000 pounds per square inch (6,895-27,580 kiloPascals) when tested according to the overlap shear test method ASTM D 1002-72.

Embodiment 33 is the article of any of embodiments 30-32, wherein the cured composition has a thermal conductivity that does not decrease when measured at a temperature of from room temperature to 250° C.

Embodiment 34 is the article of any of embodiments 30-33, wherein the substrate comprises a pipe and the cured composition comprises a pipe coating

Embodiment 35 is the article of any of embodiments 28-34, wherein the curable composition further comprises at least one additive.

Embodiment 36 is the article of embodiment 35, wherein the at least one additive comprises a filler, a thermal conductivity enhancer, a chain extension agent, a compatibilizer, a benzoxazine compound, a nanoparticle, a coupling agent, a flow promotion agent, an adhesion promotion agent, a toughening agent, fibers, fabrics, and combinations thereof.

### EXAMPLES

One-part high temperature thermoset articles were prepared. The resultant materials provide high glass transition temperatures and high strength. The compounds were also filled to make them thermally conductive as shown in the following examples.

These examples are merely for illustrative purposes only and are not meant to be limiting on the scope of the appended claims. All parts, percentages, ratios, etc. in the examples and the rest of the specification are by weight, unless noted otherwise. As used herein J=Joules; mm=millimeters; W=Watts; s=seconds; m=meters; Hz=Hertz; KN=kiloNewtons; K=Kelvin; g=grams.

### Materials

| Abbrevi- | |
|---|---|
| ation | Description |
| A1 | Solid epoxy resin, 3,8-Dihydroxy-5a,10b-DiphenylCumarano |
| | 2′,3′,2,3-Coumarane (DDCC), commercially available from |
| | Huntsman Chemicals, The Woodlands, TX as RDS 2012- |
| | 027. |
| A2 | Micronized curing agent Dicyandiamide, commercially |
| | available from Air Products and Chemicals, Inc., Allentown, |
| | PA as AIWICURE CG-1400. |
| A3 | Solid epoxy resin, Commercially available from Dow |
| | Chemical Co., Midland, MI as DER 6508. |
| A4 | Solid Benzoxazine resin, Bisphenol F Benzoxazine, |
| | commercially available from Huntsman Chemicals, The |
| | Woodlands, TX as ARALDITE MT 35700 CH. |
| B3 | Boron Nitride powder, NX1 grade, commercially available |
| | from Momentive, Waterford, NY. |
| B4 | Magnesium Oxide, commercially available from HallStar |
| | Co., Chicago, IL, as MAGLITE A. |

### Test Methods

### Overlap Shear Tests

Overlap shear adhesion tests were performed in an Instron Universal Tensile machine model 2511 (Bighamton, N.J.) with a 5 KN load cell and a temperature conditioning chamber. The test was conducted at 0.05 inches per minute.

### Differential Scanning Calorimetry

A Q 2000 DSC from TA Instruments (Newcastle, Del.) was utilized to make these measurements. The scan rate was 2 ° C. per minute.

### Dynamic Mechanical Analysis

A TA Instruments Q800 DMA (Newcastle, Del.) was utilized to make the measurements at a scan rate of 2 ° C. per minute and a frequency of 1 Hz.

### Thermal Conductivity

Thermal conductivity was calculated from thermal diffusivity, heat capacity, and density measurements according the formula:

k=α·cₚ·ρ

where k is the thermal conductivity in W·m⁻¹·K⁻¹, α is the thermal diffusivity in mm²·s⁻¹, cₚ is the specific heat capacity in J·K⁻¹·g⁻¹, and ρ is the density. The sample α and cₚ are measured using a LFA 467 “HyperFlash” (NETZSCH Instruments North America, LLC Burlington, Mass.) directly and relative to standard, respectively, according to ASTM E1461-13. Sample density was measured using a standard analytical balance following displacement methodology, i.e. the “Archimedes” method. A similar technique is mentioned in ASTM D792-13.

### EXAMPLES

Example E1 illustrates the composition and procedure to make samples for testing mechanical and thermal properties of neat and composite cured thermoset compounds. The compounds are based on a solid high temperature epoxy and a micronized powder curing agent.

### E1a

475 parts of A1 were melted on a rigid metal pan using a digital hot plate set to 230° C. The powder was molten to a clear appearance in about 2 minutes. A differential scanning calorimetry trace of A1 showed a melting endotherm peaking at 181° C. with an energy of 76 Joules/gram. This endotherm starts at 130° C. and ends at 195° C. The molten material flowed as an almost inviscid fluid at this temperature therefore allowing other materials to be dissolved in it when compatible. 25 parts of A2 were added to the molten A1 and stirred vigorously until all the mixture was homogeneous, this happened in about 1.5 minutes. The mixture was immediately removed from the heat and quenched rapidly to 20° C. in a bath of tap water. The solid material was removed from the container and pulse ground using an E160BY grinder made by Proctor Silex (Glenn Allen, Va.). The resulting powder was then applied directly to a preheated mold/metal coupon to form test specimens. The material gelled on average from 3 to 4 minutes. Strips cured for half hour at 230° C. and followed by post cure of hour at 250° C.

### E1b

A faster cure Example E1b was made. The same materials and procedure used for Example E1a were used, but the post cure was 10 minutes at 320° C.

Measurement of dynamic mechanical and thermal properties were made on Examples E1a and E1b using the procedures listed above. The data from the dynamic mechanical scans is shown from Table 1. The resulting glass transition temperature and deflection temperature were very similar for both curing profiles. Glass transition temperatures ranging from 250 to 270° C. were observed.

TABLE 1
Neat Cured Compounds Dynamic Mechanical Analysis Results.

| | Storage | Tan |
|---|---|---|
| | Modulus | Delta |
| | Deflection | Maxima |
| Compound | ° C. | ° C. |
| E1a | 255 | 269 |
| E1b | 248 | 265 |

Overlap Shear testing of E1 was conducted. ½ inch wide cold rolled steel coupons were grit blasted on one side with enough room to create a 0.5×0.5 inch overlap. Blasting was done in a Trinco Dry Blasting Machine Model #36x30/PC made by Trinity Tool Co. (Fraser, Mich.). The blast media was steel grit from Metal Tech Abrasive Co. (Canton, Mich.). A G25 grade was used. Silicon tape Scotch Brand 1280 (3M Co., St. Paul, Minn.) was utilized to ensure accurate dimensions of the bonded area, residue was also removed from all sides of the joint. The joining material was Example E1. Results from the overlap shear tests are shown in Table 2. Overlap shear strength increased with temperature. This is due to the increase toughness of the compound as temperature is increased but still below its glass transition temperature.

TABLE 2
Overlap shear adhesion on grit blasted steel of Example E1.

| | Overlap |
|---|---|
| Test | Shear |
| Temperature | Strength |
| ° C. | Mpa |
| 25 | 13.0 |
| 87 | 12.2 |
| 87 | 9.9 |
| 140 | 15.2 |
| 202 | 15.7 |
| 202 | 18.2 |
| 25 | 13.5 |
| 25 | 12.4 |
| 110 | 12.4 |
| 110 | 12.9 |
| 110 | 17.3 |
| 215 | 17.5 |
| 215 | 15.3 |
| 215 | 14.6 |
| 215 | 19.8 |

### Examples of Thermally Conductive Compounds

### E2

Example E2 was made by first melting 475 parts of Al powder and then adding 250 parts of B3 to enhance thermal conductivity. The mixture turned to a very uniform and homogeneous paste at high filler levels but was still conformable and could assume the shape of its containment. 25 parts of A2 were added after filler incorporation. The same procedure used for E1 was used, but the strips were cured for 5 minutes at 230° C. and ½ hour at 250° C. The samples were sanded to ensure smoothness of edges and sides.

### E3

The procedure used for E2 was utilized to make E3 but using B4 filler.

Examples E2 and E3 were tested using the Dynamic Mechanical Analysis test listed above. Their resulting glass transition temperature and deflection temperature are shown in Table 3. Glass transition temperatures ranging from 250 to 260° C. were observed.

TABLE 3
Filled Compounds, Dynamic Mechanical Analysis Results.

| | Storage | Tan |
|---|---|---|
| | Modulus | Delta |
| | Deflection | Maxima |
| Compound | ° C. | ° C. |
| E2 | 245 | 260 |
| E3 | 236 | 250 |

### Thermal Conductivity Measurements for E1 and E2

Samples were cut, punched, or ground into discs having diameters of approximately 12.5 mm and thicknesses in the range of 1.5-2 mm. PYROCERAM 9606 (Corning Inc., Corning, N.Y.) was used as a method standard and the heat capacity reference sample. Examples and the reference sample were coated with a graphite spray (DGF123 from Miracle Power Products, Cleveland, Ohio.) to enable similar absorptivity/emissivity for heat capacity estimation. The reference sample is measured during each sample run. Diffusivity data was fit using the Cowan +Pulse Correction model. Table 4 is a comparison between Examples E1a and E2 and shows the improvement of thermal conduction behavior upon addition of filler

B3. This improvement degraded a bit with further heat treatment, but still remained with a similar improvement magnitude of thermal conductivity over the base resin.

TABLE 4
Thermal Conductivity of cured compounds measured at room
temperature.

| | | Thermal |
|---|---|---|
| | Density | Conductivity |
| Compound | g/cm³ | W/m K |
| PyroCeram 9606 | 2.59 | 3.902 |
| PyroCeram 9606 | 2.59 | 3.904 |
| PyroCeram 9606 | 2.59 | 3.91 |
| E1a | 1.252 | 0.183 |
| E1a | 1.248 | 0.183 |
| E1a | 1.246 | 0.18 |
| E2 | 1.456 | 0.595 |
| Further cured E2 | 1.456 | 0.556 |

### C1

Comparative Example 1 was made by first melting 475 parts of A3 powder and adding 250 parts of B3 to enhance thermal conductivity. 25 parts of A2 was added after B3 incorporation. The same procedure used for E1 was used, but the strips were cured for 5 minutes at 230° C. and ½ hour at 250° C. The samples were sanded to ensure smoothness of edges and sides.

Thermal properties were measured as a function of temperature to illustrate a newly found advantage of samples made with A1 which showed no decline in thermal conductivity up to 250° C. While Comparative Cl made with A3 declined after its glass transition temperature was surpassed near 150-160° C. This is shown in Table 5 below. Note that thermal conductivity on the table is an average of two independent measurements.

TABLE 5
Thermal Conductivity of cured compounds measured over from room
temperature to above their glass transition temperature.

| | Thermal | Thermal |
|---|---|---|
| | Conductivity of | Conductivity of |
| Temperature | Compound E2 | Compound C1 |
| ° C. | W/m K | W/m K |
| 25 | 0.6145 | 0.605 |
| 50 | 0.642 | 0.633 |
| 75 | 0.6745 | 0.659 |
| 100 | 0.709 | 0.6895 |
| 125 | 0.725 | 0.7085 |
| 150 | 0.7335 | 0.7115 |
| 175 | 0.719 | 0.742 |
| 200 | 0.748 | 0.7 |
| 225 | 0.736 | 0.687 |
| 250 | 0.7795 | 0.6705 |
| 275 | 0.73 | 0.662 |

### E4 and E5

Examples 4 and 5 were made using the procedure for melting and curing described in E1a, but using blends of A4 with A1 as shown in Table 6. It was observed that the solubility of curative A2 for these blends improves as the fraction of A4 increases. These blends were tested using the dynamic mechanical analysis mentioned above. The results are shown in Table 6. This shows that the glass transition temperature of the cured blend can be manipulated by addition of A4.

TABLE 6
Tan delta maxima of dynamic mechanical traces of cured blends.

| | | Tan Delta |
|---|---|---|
| Example | Blend ratio | Maxima ° C. |
| E1a | 100 A1 | 269 |
| E4 | 75A1/25A4 | 218 |
| E5 | 50A1/50A4 | 201 |

What is claimed is:

1. A one-part curable composition comprising:
a thermally curable powder composition comprising:
at least one solid epoxy resin; and
at least one solid epoxy curative resin,
wherein the epoxy resin and the epoxy curative resin are melted, mixed, quenched and powderized.

2. The curable composition of claim 1, wherein the at least one solid epoxy resin comprises an epoxy resin that is a benzofuran diepoxide, a modified benzofuran diepoxide, or a combination thereof.

3. The curable composition of claim 1, wherein the at least one solid epoxy resin comprises an epoxy resin that is the diglycidyl ether of 3,8-dihydroxy-5a,10b-diphenyl coumarano-2′,3′,2,3-cuomarane.

4. The curable composition of claim 1, wherein the at least one solid epoxy curative resin comprises a solid phenolic hydroxyl terminated curative resin, a solid amine-based curative resin, or a solid anhydride curative resin.

5. The curable composition of claim 4, wherein the solid epoxy curative resin comprises an amine-based curative resin comprises cyanoguanidine, diphenyl sulfone diamine curatives, imidazoles, or combinations thereof.

6. The curable composition of claim 1, wherein the epoxy resin and epoxy curative resin are heated to a temperature of from 100-250° C. for 1-3 minutes and quenched by cooling to room temperature.

7. The curable composition of claim 1, wherein the curable composition is curable at a temperature of from 100-400° C. for from 1 minute up to 8 hours.

8. The curable composition of claim 1, further comprising at least one additive.

9. The curable composition of claim 8, wherein the at least one additive comprises a filler, a thermal conductivity enhancer, a chain extension agent, a compatibilizer, a benzoxazine compound, a coupling agent, a flow promotion agent, an adhesion promotion agent, a toughening agent, fibers, fabrics, and combinations thereof.

10. The curable composition of claim 9, wherein the at least one additive comprises a chain extension agent comprising an aromatic hydroxyl-functional chain extension agent.

11. The curable composition of claim 1, further comprising at least one liquid component selected from at least one liquid epoxy resin, at least liquid epoxy curative resin, or at least one liquid additive.

12. A method of preparing a coating comprising:
providing a curable composition, the curable composition comprising:
at least one solid epoxy resin; and
at least one solid epoxy curative resin, wherein the epoxy resin and the epoxy curative
resin are melted, mixed, quenched and powderized;
providing a substrate comprising a first major surface and a second major surface;
coating the curable composition on at least one major surface of the substrate; and
curing the curable composition.

13. The method of claim 12, wherein providing a curable composition comprises providing a curable composition powder or a curable composition powder dissolved in one or more solvents.

14. The method of claim 12, wherein melting, mixing and quenching the epoxy resin and epoxy curative resin comprises heating a mixture of solid epoxy resin and solid epoxy curative resin to a temperature of from 100-250° C. for 1-3 minutes and quenching by cooling to room temperature.

15. The method of claim 12, wherein melting, mixing and quenching the epoxy resin and epoxy curative resin comprises heating a mixture of solid epoxy resin to a temperature of from 100-250° C. adding and solid epoxy curative resin and maintaining the temperature of from 100-250° C. for 1-3 minutes and quenching by cooling to room temperature.

16. The method of claim 12, wherein curing the curable composition comprises heating to a temperature of from of from 100-400° C. for from 1 minute up to 8 hours.

17. An article comprising:
a first substrate having a first major surface and a second major surface; and
a coating of a curable composition on at least a portion of at least one major surface of the substrate, wherein the curable composition comprises:
at least one solid epoxy resin; and
at least one solid epoxy curative resin, wherein the epoxy resin and the epoxy curative
resin are melted, mixed, quenched and powderized.

18. The article of claim 17, further comprising a second substrate, the second substrate having a first major surface and a second major surface, wherein at least a portion of the first major surface of the second substrate is in contact with coating of the curable composition.

19. The article of claim 17, wherein the curable composition is cured.

20. The article of claim 19, wherein the cured composition has a Tg as measured by Dynamic Mechanical Analysis (DMA) of at least 150-270° C.

21. The article of claim 19, wherein the cured composition has an overlap shear value of 1,000-4,000 pounds per square inch (6,895-27,580 kiloPascals) when tested according to the overlap shear test method ASTM D 1002-72.

22. The article of claim 19, wherein the cured composition has a thermal conductivity that does not decrease when measured at a temperature of from room temperature to 250° C.

23. The article of claim 19, wherein the substrate comprises a pipe and the cured composition comprises a pipe coating.
